(19) United States
(12) Patent Application Publication
(10) Pub. No.: US 2006/0090206 A1
(43) Pub. Date: Apr. 27, 2006

(54) Method, system and apparatus for assessing vulnerability in Web services

(76) Inventors: Michael V. Ladner, Fair Oaks, CA (US); John E. Quinnell, Rocklin, CA (US); Arthur F. Walasek, Folsom, CA (US); Keith J. Smith, Rocklin, CA (US); Patrick G. Billquist, El Dorado Hills, CA (US)

Correspondence Address: DKW LAW GROUP, P.C., 58TH FLOOR - USX TOWER, 600 GRANT STREET, PITTSBURGH, PA, 15219, US

(21) Appl. No.: 11/252,217

(22) Filed: Oct. 17, 2005

Related U.S. Application Data
(60) Provisional application No. 60/619,220, filed on Oct. 15, 2004.

(51) Int. Cl. G06F 11/00

(52) U.S. Cl. 726/25

(57) ABSTRACT

Disclosed is a computer implemented method for testing a Web service to determine whether the Web service is vulnerable to at least one known vulnerability. A test case is created and executed for the Web service to determine whether the Web service is vulnerable to the vulnerability. The test case is based on at least one vulnerability definition, at least one Web service operation or port, and at least one control request. The vulnerability definition includes information required to create a request and an expected result. Also disclosed is a computer implemented method of testing a Web service to determine whether the Web service complies with a policy, for example a security or vulnerability policy. A test case is created and executed for the Web service to determine if the Web service complies to the policy.

### CROSS-REFERENCE TO RELATED APPLICATION

This application claims the benefit of U.S. Provisional Patent Application Ser. No. 60/619,220, filed Oct. 15, 2004.

### BACKGROUND OF THE INVENTION

1. Field of the Invention

The present invention relates to a method, system and apparatus for assessing vulnerability in Web services, and more particularly for testing and certifying Web services during development and testing.

2. Description of Related Art

In the late 1990's, Web technology fueled a revolution in business productivity and efficiency. Businesses converted labor-intensive processes into Web-based, self-service applications. Web postings and downloads replaced phone inquiries and mailings. Inefficiencies were wrung out of supply chains, logistics operations, and fulfillment services. The transformations reached every industry and every consumer market. Now, whether one is managing a supply chain or ordering tickets for a sports event, the approach is the same: get online and use the Web.

A Web service is a software system designed to support interoperable machine-to-machine interaction over a network. Web services are a new breed of Web application. They are self-contained, self-describing, modular applications that can be published, located, and invoked across the Web. Web services perform functions, which can be anything from simple requests to complicated business processes. Once a Web service is deployed, other applications (and other Web services) can discover and invoke the deployed service.

Web services are inaugurating another revolution in productivity. Building upon the Web server infrastructure deployed in the past decade, Web services are extending the Web's connectivity to more IT systems, including legacy systems and back-office systems, and increasing the Web's automation with sophisticated new services that accelerate an impressive range of business processes. In contrast to prior browser-centric technology, today's Web services can allow applications and systems to find one another, request and receive information, and process information without any human intervention at all. As these new services come online, businesses are experiencing a significant rise in productivity and efficiency.

These new Web services must be secure from intrusions and malicious content; otherwise, this rapid-fire transactional technology will be used to unleash unprecedented DoS (denial of service) attacks and malware intrusions deep within an enterprise. It will also be used to siphon confidential data and information assets out to competitors and criminals.

Web services expose software interfaces, system design, routing information, and business logic to the public. For example, a cornerstone of Web services is a Web Services Description Language (or Web Service Definition Language—WSDL) document, which is written in XML (extensible markup language), and which describes the services being offered and the way other users and services can interact with those services. They expose business logic and back-office systems previously invisible to Web users. Web services expose internal business assets through communications over public networks.

The legacy systems and intellectual technology assets to which Web services connect lack intelligent security mechanisms to detect intrusions. Such systems were not designed to sit on public networks and withstand hostile attacks. One of the benefits of Web services is that they can reach further into enterprise networks, connecting to databases and legacy systems that, until now, have been excluded from Web automation. This connectivity poses a risk, however, since these legacy systems have limited security features and typically trust any request made for data. Legacy systems were designed and deployed before the age of Web services. Because they were on an internal network at a location secured by a physical perimeter, they could assume that any user was legitimate and authorized. They were not designed to get requests from a trading partner 6,000 miles away making a request through Web services.

Web services themselves lack mechanisms for detecting and thwarting intrusions. Data may be being corrupted and attacks taking place without any monitoring system detecting this activity.

Currently, security is “bolted on,” not designed into XML and other basic Web services technologies that were developed without security in mind. Standards groups and software vendors are now working to add encryption, digital certificate management, and other security features to the underlying technology. Because these features are additions and still under development, their use may be overlooked or misjudged, and security gaps may remain.

Web services can be highly complex. Web services may involve multiple applications, combinations of J2EE and net technologies, and disparate IT systems deployed at various nodes on the network. This complexity is only going to increase.

The challenge of securing Web services is compounded by the way organizations develop Web services. With threats and computer technologies both evolving so quickly, computer security has become its own area of expertise, requiring on-going training and attention. Few organizations can afford to train their developers on security methodologies and the latest battery of threats. Developers are under pressure to produce software. Their expertise and their inclination are to spend time developing Web services. Consequently, security is often left to a security officer or a security team operating independently of the development team.

Because they are trained in security and versed in the latest threats, security officers may be able to write directives and guidelines for the development team to follow, but they lack an automated solution for ensuring that these directives and guidelines are systematically applied in the development of Web services. Even if security directives are applied in one release of Web services, there may not be a system for ensuring they are applied when that release is modified or replaced.

Security vulnerabilities derive from failures to comply with standards and best practices during the design and development of Web services. Web services attacks take advantage of these vulnerabilities to steal information, shut down services, or corrupt data integrity. Examples of Web services vulnerabilities include:

Lack of compliance with standards. To ensure that Web services interoperate correctly with other IT systems and that Web services take advantage of the best practices inherent in standards, developers must ensure that every release of Web services complies with standards, such as WS-I.

Lack of authentication or poorly-implemented authentication systems. Authentication must be enforced when appropriate and properly implemented, so that passwords cannot be guessed or intercepted.

Lack of protection for confidential data. Confidential data, including data in public documents, such as WSDL documents, should be properly encrypted.

Lack of compliance with best practices and coding convention guidelines. Organizations will develop their own coding conventions and best practices. Some of these best practices will be designed to address design shortcomings and security vulnerabilities found in current Web services technology or in third-party products, such as application servers.

Taking advantage of the vulnerabilities listed above, Web services hackers can execute the following types of attacks:

Probing attacks. These attacks are when hackers scan WSDL documents and other public interfaces to discover vulnerabilities. Hackers may test every operation published in a WSDL until a vulnerability is discovered, or they may test various patterns of parameters until they gain access to unauthorized information or cause a fault.

Coercive parsing. These attacks are when hackers take advantage of the verbose nature of SOAP (Simple Object Access Protocol) messages to generate attacks. For example, by changing the parameters of a request message, a hacker may create a recursive request that loops endlessly, consumes all the CPU cycles on the Web services parser, and thereby creates a DoS attack.

Replay attacks. These attacks are when a hacker issues a legitimate SOAP request repeatedly in order to deplete system resources. Because the form and content of the request are legitimate, each individual request will be treated as legitimate by firewalls and parsers. But the cumulative result of the replayed requests is a DoS attack.

External reference attacks. These attacks are when hackers take advantage of SOAP documents that reference URLs and other external resources. If a reference points to a malicious or corrupted resource, the SOAP document may be coerced to execute malicious code, grant hackers access to internal resources, or launch a DoS attack. Another type of attack involves corrupting the XML Schema a parser uses to validate XML documents. By changing the Schema, hackers can corrupt all the XML data flowing through the parser. Finally, hackers may tamper with the routing instructions in XML tags and redirect SOAP messages and their confidential payloads to unauthorized destinations.

Malicious content attacks. These attacks are when hackers embed viruses, worms, Trojan horses, or other malware in the attachments carried by SOAP messages.

It is important to recognize that vulnerabilities are exploited in production, but they originate in development and deployment, either through oversight on the part of developers or through design flaws in the current generation of Web services standards. Ideally, an especially rigorous design and development process would eliminate all vulnerabilities.

There exists a need for a tool or tools to be utilized in development environments where programmers can apply known information regarding vulnerabilities in well-designed and rigorously-tested code. There also exists a need in Web services architectures for a feedback loop connecting production systems, where lessons can be learned about the techniques and habits of hackers, to development environments, where programmers can apply these lessons in well-designed and rigorously-tested code.

### BRIEF SUMMARY OF THE INVENTION

The present invention addresses the Web services vulnerabilities described above. The present invention aids in thwarting types of attacks, including probing attacks, SQL Injections, Cross-site scripting, coercive parsing, malicious content, denial of service and others.

The present invention provides a series of methods for testing a Web service to determine if it is exposed to a known set of vulnerabilities by automatically generating a series of tests based on the interface defined for the Web service. By applying knowledge of known vulnerabilities to the development process, the present invention allows the developer to determine if the code is written in a secure fashion and, therefore, is not exposed to those vulnerabilities.

The present invention also includes a system for cataloging vulnerabilities and for ensuring that these vulnerabilities are tested against in development. By capturing knowledge about known vulnerabilities and applying this knowledge in the development process, the present invention bridges the gap between production and development in the Web services life cycle.

The present invention addresses critical security needs of developers, QA teams, and operations teams to insure secure code is being developed that is not exposed to a known set of vulnerabilities. All of these teams will be able to detect vulnerabilities and to determine that Web services are conforming to best practices designed to eliminate these vulnerabilities.

By building in and automating the application of security knowledge, the present invention obviates the need for developers to become security experts. A systematic approach enables security experts to focus on security, operations teams to focus on operations, and developers to focus on development.

The present invention integrates with existing Web services products and infrastructures. It does not force organizations to reject or retool Web services offerings they have already created.

Thus, it is an object of the invention to make vulnerability management an automatic part of Web services development. In order to achieve this, the invention has been implemented to directly interface with standard Integrated Development Environments (IDE's) including the Eclipse environment.

The present invention decreases operational expenses by identifying potential vulnerabilities prior to the deployment of the Web services.

The testing tools of the present invention are designed for Web services development and QA. These tools enable developers and QA teams to test Web services against known vulnerabilities. They also ensure that Web services follow coding guidelines and best practices.

A typical test implementation requires enumeration of an expected result (or “badness”), that is, it requires the test operator to specify the bad result so that the implementation can compare an actual result against the expected result for a match and decide whether a failure has occurred. The present invention enables enumeration of acceptable behavior through use of security or vulnerability policies (acceptable results rules). In addition, the present invention may match and report the enumerated failure results, as well as match and report pass/fail on any result except the enumerated acceptable results.

A policy rule set is created and associated to each test case for each possible combination of policy rules, modified rules, and rule omissions. The expected response for such test cases may be some type of accepted condition, an error condition, or an indeterminate result as a pass or fail condition based on Boolean logic operators contained in the rule set expression matching operation.

In the production environment, tests created during the pre-deployment phases can be run to test for potential vulnerabilities due to changes in the environment. New tests can be automatically created as new vulnerabilities are identified specific to the installation or related to commercially available off-the-shelf software that could be potential exposures.

The present invention maintains a repository, that can be shared with other systems, that enables a business to ensure that all known vulnerabilities are cataloged and accounted for in processes across departments, for example, development, QA, and operations departments.

The present invention is a proactive Web services inspection tool for use during the full product life cycle including development, quality assurance, security compliance and deployment. The invention is an easy-to-use tool that enables developers to import a WSDL document and test it for compliance with industry standards and best practices.

### DETAILED DESCRIPTION THE INVENTION

For purposes of the invention, it is to be understood that the invention may assume various alternative variations and step sequences, except where expressly specified to the contrary. It is also to be understood that the specific devices and processes discussed are simply exemplary embodiments of the invention. Hence, specific details related to the embodiments disclosed herein are not to be considered as limiting.

The present invention is a computer implementation of a method for assessing vulnerability in Web services. Typically, Web developers and quality assurance personnel will use the present invention as a test and diagnostic tool. Generally, according to the present invention, the method enables a user to test Web services for the presence of one or more known vulnerabilities of Web services by generating and executing a series of test cases.

Interfaces to a Web service can be defined by a document having contents based on Web Services Definition Language (WSDL) or by other methods for describing interfaces to a Web service. For example, one method is an interactive dialog with the user to define messages to the Web services. Another example method incorporates a detailed description that describes the interfaces in other types of documents such as a forms.

Another alternative represents all services in a standard way and through a standard set of resources. Each location contains the representation of another resource in a standard way. The tree is traversed to represent a set of resources that represents the interfaces to the Web service.

A vulnerability is a single, known weakness in an implementation or deployment of Web services which can be exploited by an attack with a known cause and effect. The application of test cases by the present invention allows for confirmation of vulnerabilities in the Web service.

Each vulnerability definition should contain a name, description, ID, simulation criteria, and an expected result description. A vulnerability meta base is a repository of known vulnerabilities, where each vulnerability may have zero or more associated vulnerability action templates. A vulnerability action template contains application specific configuration information (discussed below) to act on the associated vulnerability.

Web service vulnerability test case generation is the process of generating Web service test cases based on known vulnerabilities. A goal is to produce test cases that, when executed against a Web service, produce a pass or fail outcome, indicating whether or not a vulnerability exists in the Web service. The pass/fail outcome may be determined automatically or by a user.

A test case is either created automatically by a test case generator from information contained in a vulnerability definition or created by a user from information supplied by the user. Automated test generation is the process of selecting one or more vulnerabilities and one or more Web service (WSDL) operations, and generating test suites, test cases, and/or test operations.

A test suite is a grouping of test cases. A test case is a grouping of test operations, with control flow that will produce a pass/fail outcome when executed. If the test case is generated from a vulnerability, then an association is created between the test case and the vulnerability.

A test operation is an object that contains both a parameterized request message and an expected result and is used to validate an actual response of a Web service. Test operations will be created both by end users and through automated test generation. An incomplete test operation is defined as having no expected result. When executing an incomplete test operation, the result is always failure.

A request message is an instance of a specific Web service (or WSDL) operation message. These messages may or may not be valid (e.g., they may have invalid HTTP header information or invalid Soap messages).

An expected result is the criteria for determining whether or not an actual response satisfies the expectation (i.e., meets an expected result). Expected results can be automatically generated during automated test generation. Users can also define an expected result through validating the elements of a message using a limited number of operators or through exact message matching. The actual response is a particular instance of a response message sent from the Web service in response to a request message.

The expected result consists of an ordered set of expected result elements. Each element defines response match criteria and a match outcome. The match criteria is a set of Boolean expressions. Each expression identifies a part of the expected response, an operator, and an optional operator argument such that the question of whether or not the actual response matches the Boolean expression can be answered yes or no. An actual response matches the match criteria if it satisfies all of the Boolean expressions that make up the matching criteria. The match outcome determines the outcome of applying an actual response to the match criteria in case of a match. The match outcome is either pass or fail.

During actual response evaluation, the actual response is applied to each expected result element in the order in which the elements are defined in the expected result until a match is achieved. If no match is achieved, then the outcome of the test operation is indeterminate.

A test case generator produces test cases for a specific Web Service or set of Web Service (or WSDL) operations and vulnerability definitions. A test case generator uses the generator configuration from a given vulnerability definition, a Web service (or WSDL) operation, and a control request to produce one or more test cases

The test case generator configuration from a vulnerability definition contains all of the parameterized data required by a test case generator. A specific vulnerability action template may contain information identifying a particular test case generator and the associated test case generator configuration.

A control request and/or control response are associated with the Web service operation. The control request and/or control response are necessary to provide sufficient information to the test case generator to produce meaningful test cases.

The control request is a user validated request message corresponding to a particular Web service (or WSDL) operation that is known to be a valid request message for that operation. The actual response received following a control request should be a valid, non-error Web service response.

A user may define the control request. However, if a user-supplied control request has not been defined for a Web service operation for which the test case generator is generating test cases, the test case generator will use the default control request. The default control request for a Web service operation is constructed by supplying, for each request parameter, a value that conforms to the type of the parameter. The default control request conforms to the WSDL; however, unlike a user-defined control request, there is no guarantee that the default control request will produce a valid, non-error response from the Web service.

Once a test case has been generated, it may be executed against the Web service to produce a pass/fail outcome. A fail outcome indicates the presence of the vulnerability as defined by the vulnerability definition.

There are multiple types of test case generators, based on different types of vulnerabilities and different manipulations of request messages. Each test case generator is designed to reflect a technique necessary to produce a test case that exploits a particular vulnerability. Types of generators include parameter substitution, coercive parsing, security policy compliance, vulnerability policy compliance, overflow to consume excessive amounts of system resources, and boundary conditions. For example, a parameter substitution technique might be used to generate test cases that attempt to exploit an SQL injection vulnerability. Thus, the appropriate test case generator to use is dependent on the type of vulnerability.

Each test case generator generates tests based on a range of values for its parameters. Each type of test case generator has its own configuration requirements specific to the technique used for a vulnerability type including parameter definitions and ranges. A test case generator configuration consists of generator-specific information used to produce requests and an expected result. Each vulnerability definition contains information to configure a test case generator to produce the desired test case instances. Since there are different types of test case generators, each vulnerability definition includes a defined type of test case generator to use and appropriate configuration information for the type of test case generator.

Thus, each vulnerability definition contains the appropriate test case generator configurations. The test case generator configuration determines the type of test case generator for the particular vulnerability, as well as provides the necessary configuration information for the test case generator.

As an example, a vulnerability definition, including the corresponding test case generator configuration, is represented as an XML document. The test case generator configuration consists of a generator-specific message type and an expected result type. XML schema is defined for the vulnerability with an extension point for the test case generator configuration. XML schema is defined for each test case generator configuration that extends the vulnerability.

An example XML schema for a vulnerability definition follows:

```
<?xml version=“1.0” encoding=“UTF-8”?>
<s:schema
    elementFormDefault=“qualified”
    targetNamespace=“http://www.kenaisystems.com/schema/2005/08/generator/testcase/”
    xmlns:er=“http://www.kenaisystems.com/schema/2005/08/testmanagement/coding/”
    xmlns:s=“http://www.w3.org/2001/XMLSchema”
    xmlns:tns=“http://www.kenaisystems.com/schema/2005/08/generator/testcase/”>
    <s:import
namespace=“http://www.kenaisystems.com/schema/2005/08/testmanagement/coding/”/>
    <s:element name=“TestCase” type=“tns:TestCaseType”/>
    <s:complexType name=“TestCaseType”>
        <s:sequence>
            <s:element name=“TestOperation” type=“tns:TestOperationType”
minOccurs=“1” maxOccurs=“unbounded”/>
        </s:sequence>
    </s:complexType>
    <s:complexType name=“TestOperationType”>
        <s:sequence>
            <s:element name=“Request” type=“tns:MessageType” minOccurs=“1”
maxOccurs=“1”/>
            <s:element name=“Response” type=“er:ExpectedResultListType”
minOccurs=“1” maxOccurs=“1”/>
        </s:sequence>
    </s:complexType>
    <s:complexType name=“MessageType”>
        <s:sequence>
            <s:any processContents=“lax”/>
        </s:sequence>
    </s:complexType>
</s:schema>
```

An example XML schema for an expected result used by the vulnerability XML schema follows:

```
<?xml version=“1.0” encoding=“UTF-8”?>
<xs:schema
    elementFormDefault=“qualified”
    targetNamespace=“http://www.kenaisystems.com/schema/2005/08/testmanagement/coding/”
    xmlns:xs=“http://www.w3.org/2001/XMLSchema”
    xmlns:tns=“http://www.kenaisystems.com/schema/2005/08/testmanagement/coding/”>
    <xs:element name=“ExpectedResultList” type=“tns:ExpectedResultListType”>
        <xs:annotation>
            <xs:documentation>Comment describing your root
element</xs:documentation>
        </xs:annotation>
    </xs:element>
    <xs:complexType name=“ExpectedResult”>
        <xs:sequence>
            <xs:element name=“Name” type=“xs:string”/>
            <xs:element name=“MatchIsSuccess” type=“xs:boolean”/>
            <xs:element name=“SequenceId” type=“xs:unsignedShort”/>
            <xs:sequence>
                <xs:element name=“ExpressionList”
type=“tns:ExpressionListType” maxOccurs=“unbounded”/>
            </xs:sequence>
        </xs:sequence>
    </xs:complexType>
    <xs:complexType name=“Expression”>
        <xs:sequence>
            <xs:element name=“SequenceId” type=“xs:unsignedShort”/>
            <xs:element name=“LValueType” type=“tns:ExpressionValueType”/>
            <xs:element name=“LValue” type=“xs:string”/>
            <xs:element name=“RValueType” type=“tns:ExpressionValueType”
minOccurs=“0”/>
            <xs:element name=“RValue” type=“xs:string” minOccurs=“0”/>
            <xs:element name=“RelationalOperator”
type=“tns:RelationalOperatorType”/>
            <xs:sequence>
                <xs:element name=“NameSpaceContextList”
type=“tns:NameSpaceContextListType” minOccurs=“0”/>
            </xs:sequence>
        </xs:sequence>
    </xs:complexType>
    <xs:complexType name=“ExpectedResultListType”>
        <xs:sequence>
            <xs:element name=“ExpectedResult” type=“tns:ExpectedResult”
maxOccurs=“unbounded”/>
        </xs:sequence>
    </xs:complexType>
    <xs:complexType name=“ExpressionListType”>
        <xs:sequence>
            <xs:element name=“Expression” type=“tns:Expression”
maxOccurs=“unbounded”/>
        </xs:sequence>
    </xs:complexType>
    <xs:simpleType name=“ExpressionValueType”>
        <xs:restriction base=“xs:string”>
            <xs:enumeration value=“EMPTY”/>
            <xs:enumeration value=“LITERAL”/>
            <xs:enumeration value=“XPATH”/>
            <xs:enumeration value=“REGULAR_EXPRESSION”/>
        </xs:restriction>
    </xs:simpleType>
    <xs:simpleType name=“RelationalOperatorType”>
        <xs:restriction base=“xs:string”>
            <xs:enumeration value=“EQUALS”/>
            <xs:enumeration value=“NOT_EQUAL”/>
            <xs:enumeration value=“LESS_THAN”/>
            <xs:enumeration value=“LESS_THAN_OR_EQUAL_TO”/>
            <xs:enumeration value=“GREATER_THAN”/>
            <xs:enumeration value=“GREATER_THAN_OR_EQUAL_TO”/>
            <xs:enumeration value=“EXISTS”/>
            <xs:enumeration value=“DOES_NOT_EXIST”/>
            <xs:enumeration value=“STARTS_WITH”/>
            <xs:enumeration value=“CONTAINS”/>
            <xs:enumeration value=“DOES_NOT_CONTAIN”/>
            <xs:enumeration value=“MATCHES”/>
            <xs:enumeration value=“DOES_NOT_MATCH”/>
        </xs:restriction>
    </xs:simpleType>
    <xs:complexType name=“NameSpaceContextType”>
        <xs:sequence>
            <xs:element name=“Prefix” type=“xs:string”/>
            <xs:element name=“URI” type=“xs:string”/>
        </xs:sequence>
    </xs:complexType>
    <xs:complexType name=“NameSpaceContextListType”>
        <xs:sequence maxOccurs=“unbounded”>
            <xs:element name=“NameSpaceContextElement”
type=“tns:NameSpaceContextType”/>
        </xs:sequence>
    </xs:complexType>
    </xs:schema>
```

A parameter substitution test case generator produces test cases by replacing parameter values in the control request with values defined in the parameter substitution test case generator configuration. Replacement of parameter values occurs when the parameter type matches the type specified in the parameter substitution test case generator configuration. The parameter substitution test case generator configuration specifies: (1) a single XML schema type and one or more values, and (2) an expected result.

Given a Web service operation and control request, for each parameter value in the control request, if the parameter type matches the configuration type, then one or more requests are created by replacing the existing parameter value with each value specified in the configuration. For each generated request, a test case is created containing the generated request along with the expected response defined in the configuration. A type match occurs if the parameter type is the same as or is derived from the specified type in the configuration.

An example XML schema for a parameter substitution test case generator follows:

```
<s:schema
    elementFormDefault=“qualified”
    targetNamespace=“http://www.kenaisystems.com/schema/2005/generator/message/ParameterSubstitution/”
    xmlns:tc=“http://www.kenaisystems.com/schema/2005/08/generator/testcase/”
    xmlns:s=“http://www.w3.org/2001/XMLSchema”
    xmlns:tns=“http://www.kenaisystems.com/schema/2005/generator/message/ParameterSubstitution/”>
    <s:import
namespace=“http://www.kenaisystems.com/schema/2005/08/generator/testcase/”/>
    <s:element name=“ParameterSubstitution” type=“tns:ParameterSubstitutionType”/>
    <s:complexType name=“ParameterSubstitutionType”>
        <s:complexContent>
            <s:restriction base=“tc:MessageType”>
                <s:sequence>
                    <s:element name=“Type” minOccurs=“1”
maxOccurs=“1”>
                        <s:complexType>
                            <s:sequence>
                                <s:element name=“Namespace”
type=“s:string” minOccurs=“1” maxOccurs=“1”/>
                                <s:element name=“Name”
type=“s:string” minOccurs=“1” maxOccurs=“1”/>
                            </s:sequence>
                        </s:complexType>
                    </s:element>
                    <s:element name=“Value” type=“s:string” minOccurs=“1”
maxOccurs=“unbounded”/>
                </s:sequence>
            </s:restriction>
        </s:complexContent>
    </s:complexType>
</s:schema>
```

A policy is used to establish context and rules in the development and deployment of a Web service. By using policies and testing for compliance to the policies, organizations can assure that the Web service is implemented to meet security and quality standards.

Policy assertions state requirements of the Web service. Each assertion represents an individual preference, requirement, capability, or other property. A set of assertions are aggregated into a policy. The Web service must adhere to these requirements to achieve compliance with the policy. Policies may be viewed as organization-defined known vulnerabilities. In other words, a policy represent vulnerability mitigation or pre-emption, since failure occurs when the policy is not followed, in that vulnerabilities appear.

A policy may be associated with a Web service by attaching the policy to a Web service policy subject. There are two policy subjects defined in the present invention: port and operation (Web service operation or WSDL operation). A policy attached to a port applies to all operations contained by the port; a policy attached to an operation applies only to the operation. Therefore, for a particular operation, it is possible for two policies to be applicable.

A security policy is a set of generation configuration objects allowing the user to setup security rules dynamically applied at request message generation.

A security policy test case generator produces test cases to test for Web service compliance with security policies that have been associated with the Web service. A security policy is a group of security assertions applied to a policy subject.

The present invention includes several policy assertions, such as:
Username Token Assertion—requires the presence of a username token in the message
Confidentiality Assertion—requires that some part of the message be encrypted
Integrity Assertion—requires that some part of the message be signed
X.509 Token Assertion—requires the presence of an X.509 token in the message
HTTPS Assertion—requires that SSL transport be used for sending the message
HTTP Basic Authentication Assertion—requires that HTTP basic authentication be used
Message Age Assertion—requires the presence of a timestamp in the message

For example, a security policy can assert that a Web service (or WSDL) operation must have an X.509 certificate. Then, the Web service must require the presence of an X.509 token in the message. If not, then the Web service is not in compliance with the policy assertion and, thus, the security policy.

The security policy assertions are preferably structured within the security policy using two operators: “all” and “exactly one”. The operators are used to indicate whether all of a set of assertions are applicable (the “all” operator) or exactly one assertion from a set of assertions is applicable (the “exactly one” operator). The operators may nest to arbitrary depths.

When a user attaches a security policy to a Web service port or operation, a set of policy rules are generated and associated with the attachment. The policy rule set is based on the security policy. The structure of the policy rule set parallels the security policy. Thus, for every policy assertion/operator in the security policy, there is a corresponding policy rule/operator in the rule set. While the security policy describes the requirements of the Web service, the policy rule set describes how the present invention should meet the requirements. The policy rule set, in effect, is a set of instructions on how to modify the request message just prior to sending the message to the Web service.

A policy rule set conforms to a security policy if all of its policy rules conform to the corresponding policy assertions in the security policy. A policy rule conforms to a policy assertion if the message that results by applying the policy rule would meet the requirements as defined by the policy assertion. For example, given a username token assertion with a password type of “Digest”, a policy rule that specified the password type to be “Text” would not conform to the policy assertion. Similarly, omitting the policy rule would not conform to the policy assertion.

A policy rule set is executed by a policy rule engine on a request of a test case (where the request is from a test operation) just prior to sending the request to the Web service. Execution of a policy rule set is the process of modifying the request based on each policy rule in the policy rule set. The policy rules are applied in the order in which they appear in the policy rule set. Policy rule sets associated with operation attachments are applied before policy rule sets associated with port attachments.

The policy rule sets attached to a Web service port and/or operation are shared by all requests that result from invoking the Web service operation. If desired, for a single request, the user may override the shared rule sets by copying them into a single rule set, modifying the copy, and associating it with the request. If the request is saved or designated as a control request, the association with the overridden policy rule set is maintained.

The effective policy rule set for a particular request is the combined policy rule sets associated with the Web service port attachment and operation attachment, or if overridden, the overriding policy rule set.

The security policy test case generator produces test cases by generating requests, based on the control request, in which an overriding policy rule set is created and manipulated based on criteria in the vulnerability definition. Two types of security policy rule set manipulations are possible: (1) omitting one or more policy rules, and (2) modifying attributes of one or more policy rules. A combination of (1) and (2) is also possible.

The vulnerability definition may specify one or more security policy assertion types to be omitted. Based on this information, the security policy test case generator will, for each operation, generate a test case for each possible combination of policy rule omissions. For example, if the vulnerability definition specified username token and confidentiality token, and if the control request for the operation contained an effective policy rule set with one username token rule and two confidentiality rules, then the following test cases would be generated for this operation:

(1) omit username token rule,

(2) omit confidentiality rule #1,

(3) omit confidentiality rule #2,

(4) omit username token rule and confidentiality rule #1,

(5) omit username token rule and confidentiality rule #2,

(6) omit confidentiality rule #1 and confidentiality rule #2,

(7) omit all three rules (username token rule, confidentiality rule #1, confidentiality rule #2).

The security policy test case generator would create for each test case the appropriate policy rule set and associate it with the test case request. Thus, each test case request has an overriding policy rule set. (The policy rule set overrides any shared policy rule set associated with policy attachments or replaces the overriding policy rule set, if any, of the control request.)

The expected response for such test cases is some type of error condition. If such a response is not received, the outcome is fail.

A vulnerability policy is a group of vulnerability definitions applied to a policy subject. Each definition represents a specific vulnerability, such as an SQL injection of bad characters.

A vulnerability policy has no effect until the user attaches the policy to a policy subject (Web service or WSDL port or operation). If the policy is attached to a port, it will apply to all operations below the port. The port policy can be supplemented for an operation by attaching a policy to the operation. A series of vulnerability tests will then be generated by a vulnerability policy test case generator to insure tests are run that exhaustively test for the type of vulnerabilities as defined by the policy.

A test suite is created that represents the set of tests dictated by the vulnerability policy. The test suite is used to confirm that the expected results are achieved. Pass/fail is determined based on the expected response being in compliance with the defined response for the vulnerability policy.

In summary, for policies, test cases are generated based on the policies attached to the Web service (WSDL) port and/or operations. For security policies, test case generators take security specific vulnerability definitions, Web service (WSDL) operations, and control requests as input and create a set of test cases (by manipulating the effective policy rule sets of the control requests) for compliance to the security policy. For vulnerability policies, test case generators take the vulnerability definitions as defined by the vulnerability policy (which may or may not be security specific vulnerability definitions), Web service (WSDL) operations, and control requests as input and create a set of tests for compliance with the vulnerability policy.

Test cases can also be generated to insure that the Web service handles anomalous traffic in an expected manner. For example, if a policy requires the use of a username token, a test could be generated to check for appropriate behavior when a request is made inconsistent with the policy, attempting to access the service without the appropriate username token. In this type of request, one might expect that the service return an error. If it does, the test would pass since the request is rejected due to the lack of a username token.

A coercive parsing test case generator creates SOAP requests that would cause failures in the Web service by attacking the parsers that are interpreting the SOAP request. The generator would generate a series of tests that would include messages that may appear to be valid SOAP requests, but actually go beyond in various ways. This includes the generation of requests that have recursive references, embedded references for non-existing object and other types of errors that may crash the parser or the service. The generator accepts input parameters regarding the complexity of the request, including the size of the Soap messages, the depth of recursion and the types of errors to generate. Based on this description, the generator analyzes known types of parser faults and generates appropriate levels of messages to attempt to cause the parser to fail in some unexpected way.

It will be understood by those skilled in the art that while the foregoing description sets forth in detail preferred embodiments of the present invention, modifications, additions, and changes might be made thereto without departing from the spirit and scope of the invention.

What is claimed is:

1. A computer implemented method, comprising the step of:
testing a Web service to determine whether the Web service is vulnerable to at least one known vulnerability.

2. The method according to claim 1, wherein the step of testing the Web service includes the step of:
executing a test case for the Web service to determine whether the Web service is vulnerable to the at least one known vulnerability.

3. The method according to claim 2, wherein the step of executing a test case includes the step of:
creating the test case based on at least one vulnerability definition, at least one Web service operation, and at least one control request.

4. The method according to claim 3, wherein the Web service operation is a WSDL operation.

5. The method according to claim 2, wherein the step of executing a test case includes the step of:
creating the test case based on at least one vulnerability definition, at least one Web service port, and at least one control request.

6. The method according to claim 3, wherein the at least one vulnerability definition includes information required to create a request and an expected result.

7. The method according to claim 2, wherein the test case includes one or more test operations.

8. The method according to claim 7, wherein each test operation includes a request and an expected result.

9. The method according to claim 8, wherein the expected result is generated by a user.

10. The method according to claim 8, wherein the expected result is generated automatically.

11. The method according to claim 8, wherein the execution of the test case includes the steps of, for each test operation:
sending the request to the Web service; and
receiving an actual response from the Web service.

12. The method according to claim 11, wherein the execution of the test case further includes the step of:
comparing the actual response to the expected result.

13. The method according to claim 12, wherein the step of comparing the actual response to the expected result is accomplished automatically.

14. The method according to claim 13, wherein the execution of the test further includes the step of:
providing an indication of whether the comparison of the actual response to the expected result produces a pass or fail outcome.

15. The method according to claim 12, wherein the step of comparing the actual response to the expected result is accomplished by a user.

16. The method according to claim 3, wherein the at least one vulnerability definition is selected from a set of known vulnerability definitions.

17. The method according to claim 3, wherein the test includes one or more test cases.

18. The method according to claim 3, wherein the step of creating the test case is accomplished by a user.

19. The method according to claim 3, wherein the step of creating the test case is accomplished automatically.

20. A computer implemented method, comprising the step of:
testing a Web service to determine whether the Web service complies with a policy.

21. The method according to claim 20, wherein the step of testing the Web service includes the step of:
executing a test case for the Web service to determine whether the Web service complies with the policy.

22. The method according to claim 21, wherein the step of executing a test case includes the step of:
creating the test case based on at least one policy, at least one selected Web service operation, and at least one control request.

23. The method according to claim 22, further including the steps of:
testing the Web service to determine whether the Web service is vulnerable to at least one known vulnerability including the steps of:
sending at least one request to the Web service; and
for each request, receiving an actual response from the Web service,
wherein for each selected Web service operation, the test case manipulates the request prior to sending the request to the Web service.

24. The method according to claim 22, wherein the Web service operation is a WSDL operation.

25. The method according to claim 21, wherein the step of executing a test case includes the step of:
creating the test case based on at least one policy, at least one Web service port, and at least one control request.

26. The method according to claim 21, wherein the policy includes one or more policy assertions.

27. The method according to claim 21, wherein the policy is a security policy.

28. The method according to claim 21, wherein the policy is a vulnerability policy.
